(19) United States
(12) Patent Application Publication
(10) Pub. No.: US 2025/0144556 A1
(43) Pub. Date: May 8, 2025

(54) METHOD FOR PRODUCING PURIFIED GAS, AND EQUIPMENT FOR PRODUCING THE SAME

(71) Applicant: AIR WATER INC., Osaka (JP)

(72) Inventors: Nanako NISHII, Osaka (JP); Masayuki KANEKO, Osaka (JP); Takanori KAIGAWA, Osaka (JP); Leona GOHDA, Osaka (JP)

(21) Appl. No.: 18/730,128

(22) PCT Filed: Jan. 17, 2023
(86) PCT No.: PCT/JP2023/001123

§ 371 Date: Jul. 18, 2024

(30) Foreign Application Priority Data
Jan. 18, 2022 (JP) 2022-005732
Dec. 26, 2022 (JP) 2022-208780

(51) Int. Cl. B01D 53/047; C01B 32/50

(52) U.S. Cl. CPC B01D 53/0476; C01B 32/50; B01D 2257/504

(57) ABSTRACT

A method for producing a purified gas containing carbon dioxide gas, comprising: a first concentration step in which an intermediate gas having a higher concentration of carbon dioxide gas than a target gas is produced by vacuum regeneration pressure swing adsorption using a first adsorption tower that adsorbs carbon dioxide gas from the target gas containing carbon dioxide gas; and a second concentration step in which a purified gas having an even higher concentration of carbon dioxide gas than the intermediate gas is produced by vacuum regeneration pressure swing adsorption or pressure swing adsorption using a second adsorption tower that adsorbs carbon dioxide gas from the intermediate gas or membrane separation.

### TECHNICAL FIELD

The present disclosure relates to a method for producing a purified gas, and equipment for producing the same.

### BACKGROUND ART

In recent years, methods for recovering and reusing carbon dioxide gas (CO₂) in exhaust gas discharged from factories and the like have been studied to reduce global greenhouse gas. Recovered carbon dioxide gas can effectively be used by, for example, concentration to a concentration of 80 vol % or more.

For example, PTL] (Japanese Patent Laying-Open No. 2021-35654) discloses that carbon dioxide gas in exhaust gas is concentrated with a temperature swing adsorption device. PTL 2 (Japanese Patent Laying-Open No. 6-327936) discloses that a low concentration of carbon dioxide gas is concentrated in two steps, wherein the carbon dioxide gas is concentrated with a membrane-type separation device in the first step, and with a pressure swing adsorption device or a vacuum regeneration pressure swing adsorption device in the second step. PTL 3 (Japanese Patent Laying-Open No. 2019-13883) discloses that air is concentrated in two steps, wherein the air is concentrated with a pressure swing adsorption device in the first step, and with a vacuum aspiration separation device, a pressure fluctuation separation device, a membrane-type separation device, or a cryogenic distillation device in the second step to separate a high concentration of oxygen.

### CITATION LIST

### Patent Literature

PTL 1; Japanese Patent Laying-Open No. 2021-35654
PTL 2: Japanese Patent Laying-Open No. 6-327936
PTL 3: Japanese Patent Laying-Open No. 2019-13883

### SUMMARY OF INVENTION

### Technical Problem

PTL 1 discloses that a purge step to discharge gas such as nitrogen remaining in vacant spaces in an adsorption tower while the pressure is reduced is included after the adsorption step for carbon dioxide gas and before the recovery step therefor. However, the carbon dioxide gas adsorbed in the purge step is also desorbed to result in lower recovery rates. In addition, a vacuum pump is needed in the purge step, and hence a large facility is needed. Moreover, a heat source is further required to increase the temperature in the adsorption tower, leading to poor energy efficiency.

PTL 2 discloses that gas containing carbon dioxide gas before the first step or before the second step is dehumidified by using a heat source in a nearby facility. However, the need for a heat source in a nearby facility limits the installation site. In addition, the need for a heat source leads to poor energy efficiency. Furthermore, the apparatus disclosed in PTL 2 includes many components, and thus needs a large facility.

It is an object of the present disclosure to provide a method for producing a purified gas which is capable of extracting a purified gas containing a high concentration of carbon dioxide gas while reducing energy consumption, and equipment for producing a purified gas.

### Solution to Problem

[1] A method for producing a purified gas containing carbon dioxide gas, comprising:
   a first concentration step in which an intermediate gas having a higher concentration of carbon dioxide gas than a target gas is produced by vacuum regeneration pressure swing adsorption using a first adsorption tower that adsorbs carbon dioxide gas from the target gas containing carbon dioxide gas; and
   a second concentration step in which a purified gas having an even higher concentration of carbon dioxide gas than the intermediate gas is produced by vacuum regeneration pressure swing adsorption or pressure swing adsorption using a second adsorption tower that adsorbs carbon dioxide gas from the intermediate gas or membrane separation.
[2] The method for producing a purified gas according to [1], wherein the target gas has a carbon dioxide gas concentration of 3 vol % or more and 70 vol % or less.
[3] The method for producing a purified gas according to [1] or [2], wherein the intermediate gas has a carbon dioxide gas concentration of 50 vol % or more and 80 vol % or less.
[4] The method for producing a purified gas according to any one of [1] to [3], wherein the purified gas has a carbon dioxide gas concentration of 80 vol % or more.
[5] The method for producing a purified gas according to any one of [1] to [4], wherein the first concentration step and the second concentration step do not have a purge step to discharge impurities in the first adsorption tower and the second adsorption tower.
[6] The method for producing a purified gas according to any one of [1] to [5], wherein two or more of the first adsorption towers and two or more of the second adsorption towers are used.
[7] The method for producing a purified gas according to any one of [1] to [6], wherein in the second concentration step, carbon dioxide gas is concentrated at a higher pressure than in the first concentration step.
[8] An apparatus for producing a purified gas containing carbon dioxide gas, comprising:
   a first concentration device that produces an intermediate gas having a higher concentration of carbon dioxide gas than a target gas, wherein the first concentration device includes a first adsorption tower that adsorbs carbon dioxide gas in the target gas containing carbon dioxide gas by vacuum regeneration pressure swing adsorption; and
   a second concentration device that produces a purified gas having an even higher concentration of carbon dioxide gas than the intermediate gas, wherein the second concentration device includes a second adsorption tower that adsorbs carbon dioxide gas in the intermediate gas by vacuum regeneration pressure swing adsorption or pressure swing adsorption or a membrane separation device that selectively passes carbon dioxide gas in the intermediate gas.
[9] The apparatus for producing a purified gas according to [8], including two or more of the first adsorption towers and two or more of the second adsorption towers.

### Advantageous Effects of Invention

According to the present disclosure, it is possible to provide a method for producing a purified gas which is capable of extracting a purified gas containing a high concentration of carbon dioxide gas while reducing energy consumption, and an apparatus for producing a purified gas.

### BRIEF DESCRIPTION OF DRAWINGS

FIG. 1 is a schematic flow diagram of a method for producing a purified gas according to an embodiment of the present disclosure.

FIG. 2 is a schematic diagram showing an example of configuration of an apparatus for producing a purified gas according to an embodiment of the present disclosure.

### DESCRIPTION OF EMBODIMENTS

Hereinbelow, embodiments of the present disclosure will be described. However, the following description does not limit the claims.

### <Method for Producing Purified Gas>

A method for producing a purified gas according to the present disclosure includes:
a first concentration step in which an intermediate gas having a higher concentration of carbon dioxide gas than a target gas is produced by vacuum regeneration pressure swing adsorption using a first adsorption tower that adsorbs carbon dioxide gas from the target gas containing carbon dioxide gas; and
a second concentration step in which the purified gas having an even higher concentration of carbon dioxide gas than the intermediate gas is produced by vacuum regeneration pressure swing adsorption or pressure swing adsorption using a second adsorption tower that adsorbs carbon dioxide gas from the intermediate gas or membrane separation.

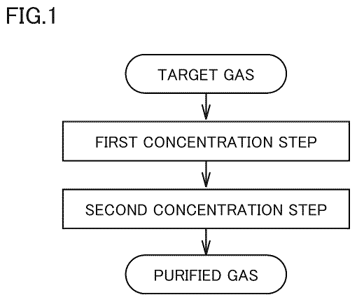

FIG. 1 is a schematic flow diagram of a method for producing a purified gas according to an embodiment of the present disclosure. Hereinbelow, each of steps of the method for producing a purified gas will be described. It should be noted that the method for producing a purified gas according to the present disclosure is described with reference to a case where a purified gas is produced through two steps: a first concentration step and a second concentration step, but the number of steps is not limited to two and a concentration step may further be included.

### (First Concentration Step)

The first concentration step is a step in which an intermediate gas having a higher concentration of carbon dioxide gas than a target gas is produced by vacuum regeneration pressure swing adsorption using a first adsorption tower that adsorbs carbon dioxide gas from the target gas containing carbon dioxide gas. This step includes (1) an adsorption step, (2) a vacuum evacuation step, and (3) a pressure-restoring step.

The “target gas” herein means a gas containing at least carbon dioxide gas. The concentration of carbon dioxide gas in the target gas is preferably 3 vol % or more and 70 vol % or less, more preferably 5 vol % or more and 50 vol % or less, even more preferably 10 vol % or more and 50 vol % or less. The target gas may contain another gas as long as carbon dioxide gas is contained. The target gas may be, for example, exhaust gas from a factory or a farm. For example, the target gas is taken in from outside and introduced into the first adsorption tower. It should be noted that when exhaust gas is used as the target gas, harmful substances contained in the exhaust gas, such as nitrogen oxide (NOx) and sulfur oxide (SOx), are preferably removed by appropriate treatment.

The “intermediate gas” herein means a gas having a higher concentration of carbon dioxide gas than the target gas. The concentration of carbon dioxide gas in the target gas is preferably 50 vol % or more and 80 vol % or less, more preferably 60 vol % or more and 80 vol % or less. The intermediate gas may contain another gas as long as carbon dioxide gas is contained.

### (1) Adsorption Step

This step is a step in which the target gas is introduced into the first adsorption tower to adsorb carbon dioxide gas. The first adsorption tower is filled with a carbon dioxide gas adsorbent to recover carbon dioxide gas contained in the target gas. Examples of the carbon dioxide gas adsorbent include silica gel, activated alumina, activated carbon, zeolite, metal organic framework (MOF), and solid amine. Among them, zeolite is preferred from the viewpoint of adsorption capacity. The first adsorption tower may be filled with a combination of two or more carbon dioxide gas adsorbents.

The first adsorption tower may be filled with a moisture adsorbent to recover moisture contained in the target gas. This is because when moisture is contained, for example, a disadvantage may occur that the adsorption capacity for carbon dioxide gas is lowered by the adsorption of moisture on the carbon dioxide gas adsorbent. Examples of the moisture adsorbent include silica gel, activated alumina, and hydrophobic zeolite. Among them, activated alumina is preferred from the viewpoint of adsorption capacity. The first adsorption tower may be filled with a combination of two or more moisture adsorbents. When the first adsorption tower is filled with a moisture adsorbent, the target gas does not need to be dehumidified before introducing the target gas to the first adsorption tower.

The carbon dioxide gas adsorbent and moisture adsorbent filling the first adsorption tower are preferably filling in the inlet side of the first adsorption tower (the target gas introduction side of the first adsorption tower), Filling in such a manner allows carbon dioxide gas and moisture to be efficiently adsorbed on the adsorbents.

The amounts of the carbon dioxide gas adsorbent and moisture adsorbent to fill the first adsorption tower can be varied in an appropriate manner according to the composition of the target gas and the types of the adsorbents to be used.

In this step, two or more first adsorption towers are preferably used. By using two or more first adsorption towers, the adsorption step is continuously performed. It should be noted that although the adsorption step is not continuously performed, this step can also be performed using only one first adsorption tower.

This step may be performed under a pressure of, for example, 5 kPaG or more and less than 0.1 MPaG.

### (2) Vacuum Evacuation Step

This step is a step in which the pressure of a gas after the adsorption step is reduced by a vacuum pump to recover an intermediate gas. In this step, the pressure is reduced to negative pressure and may be reduced to, for example, a low vacuum pressure of more than −60 kPaG. By reducing the pressure in such a way, an intermediate gas can efficiently be recovered.

### (3) Pressure-Restoring Step

This step is a step in which the pressure in the first adsorption tower after the vacuum evacuation step is restored. This step is performed by, for example, introducing a gas at atmospheric pressure. The gas at atmospheric pressure may be, for example, the target gas or exhausted gas discharged from the first adsorption tower after removing carbon dioxide gas in the adsorption step.

### (4) Others

It is preferred that the first concentration step does not include a purge step to discharge a component other than carbon dioxide gas in the first adsorption tower. The “purge step” herein is a step in which carbon dioxide gas is flowed into the first adsorption tower between the adsorption step and the vacuum evacuation step to remove a component other than carbon dioxide gas (e.g., nitrogen gas) present in voids in the first adsorption tower. When the first concentration step includes the purge step, the first adsorption tower requires a blower for carbon dioxide gas, which increases the size of facilities and energy consumption. Even when the purge step is not performed, carbon dioxide gas is further concentrated in the second concentration step that will be described later, and therefore energy consumption can be reduced by not performing the purge step.

### (Second Concentration Step)

The second concentration step is a step in which a purified gas having an even higher concentration of carbon dioxide gas than an intermediate gas containing carbon dioxide gas is produced by vacuum regeneration pressure swing adsorption or pressure swing adsorption using a second adsorption tower that adsorbs carbon dioxide gas from the intermediate gas containing carbon dioxide gas, or by membrane separation. When a purified gas is produced by vacuum regeneration pressure swing adsorption, this step includes (1) an adsorption step, (2) a pressure equalization step, (3) an atmospheric evacuation step, (4) a vacuum evacuation step, and (5) a pressure-restoring step. When a purified gas is produced by pressure swing adsorption, this step includes (1) an adsorption step, (2) an atmospheric evacuation step. (3) a recovery step, and (4) a pressure-restoring step. Further, when a purified gas is produced by membrane separation, this step includes a separation step.

The “purified gas” herein means a gas having a higher concentration of carbon dioxide gas than the intermediate gas. The concentration of carbon dioxide gas in the target gas is preferably 80 vol % or more, more preferably 85 vol % or more. The purified gas may contain another gas as long as carbon dioxide gas is contained.

### (1) Method by Vacuum Regeneration Pressure Swing Adsorption

### (1) Adsorption Step

This step is a step to adsorb carbon dioxide gas contained in the intermediate gas. The second adsorption tower is filled with a carbon dioxide gas adsorbent to recover carbon dioxide gas contained in the intermediate gas. Examples of the carbon dioxide gas adsorbent include silica gel, activated alumina, activated carbon, zeolite, MOF, and solid amine The second adsorption tower may be filled with a combination of two or more carbon dioxide gas adsorbents.

In this step, two or more second adsorption towers are preferably used, and three or more second adsorption towers are more preferably used. By using two or more second adsorption towers, the adsorption step is continuously performed. It should be noted that although the adsorption step is not continuously performed, this step may also be performed by using only one second adsorption tower.

In this step, the intermediate gas needs to be compressed and is preferably compressed to 0.1 MPaG or more. When the intermediate gas is not compressed, the amount of carbon dioxide gas adsorbed to the second adsorption tower is reduced. This step is preferably performed at a higher pressure than the adsorption step in the first concentration step.

### (ii) Pressure Equalization Step

This step is a step in which a gas is transferred between the second adsorption tower after the adsorption step and the other second adsorption tower to equalize the pressure. The second adsorption tower just after the end of the adsorption step is in a pressurized state, and therefore a gas is transferred between the second adsorption tower just after the end of the adsorption step and the other second adsorption tower in a depressurized state just after the end of a recovery step to equalize the pressure between the both.

(iii) Atmospheric Evacuation Step

This step is a step in which a gas is discharged from the second adsorption tower that has been subjected to the pressure equalization step to reduce the pressure in the second adsorption tower to atmospheric pressure. It should be noted that the discharged gas may be introduced again into the second adsorption tower without being discharged to the atmosphere

### (iv) Vacuum Evacuation Step

This step is a step in which the pressure of a gas after the atmospheric evacuation step is reduced by a vacuum pump to recover a purified gas. In this step, the pressure is reduced to negative pressure and may be reduced to, for example, a low vacuum pressure of more than −60 kPaG. By reducing the pressure in such a way, a purified gas can efficiently be recovered.

### (v) Pressure-Restoring Step

This step is a step to restore the pressure in the adsorption tower after the vacuum evacuation step. This step is performed by, for example, introducing a gas at atmospheric pressure. The gas at atmospheric pressure may be, for example, exhausted gas discharged from the second adsorption tower after removing carbon dioxide gas in the adsorption step.

### (vi) Others

As in the case of the first concentration step, it is preferred that the second concentration step does not include a purge step to discharge a component other than carbon dioxide gas in the first adsorption tower. It should be noted that the purge step is the same as that described above with reference to the first concentration step, and therefore the description thereof will not be repeated.

### (2) Method by Pressure Swing Adsorption

Also this method includes the adsorption step, the atmospheric evacuation step, and the pressure-restoring step included in the method by vacuum regeneration pressure swing adsorption, and therefore the description thereof will not be repeated. The method by pressure swing adsorption differs from the method by vacuum regeneration pressure swing adsorption in that while a purified gas is recovered by reducing the pressure to negative pressure with a vacuum pump in the method by vacuum regeneration pressure swing adsorption, a purified gas is recovered at normal pressure in the method by pressure swing adsorption. As with the method by vacuum regeneration pressure swing adsorption, it is preferred that the method by pressure swing adsorption does not include a purge step to discharge a component other than carbon dioxide gas in the first adsorption tower.

### (3) Method by Membrane Separation

This method includes a separation step in which the intermediate gas is introduced into a separation membrane that selectively passes carbon dioxide gas to separate carbon dioxide gas. In this step, the intermediate gas is compressed and then introduced into the separation membrane, and therefore the difference in partial pressure across the membrane drives separation. In this step, the intermediate gas is preferably compressed to 0.2 MPaG or more.

In the present disclosure, the second concentration step is preferably performed by the method using vacuum regeneration pressure swing adsorption from the viewpoint of energy consumption.

### <Apparatus for Producing Purified Gas>

An apparatus for producing a purified gas according to the present disclosure includes:

a first concentration device that produces an intermediate gas having a higher concentration of carbon dioxide gas than a target gas, the first concentration device including a first adsorption tower that adsorbs carbon dioxide gas in the target gas containing carbon dioxide gas by vacuum regeneration pressure swing adsorption; and

a second concentration device that produces a purified gas having an even higher concentration of carbon dioxide gas than the intermediate gas, the second concentration device including a second adsorption tower that adsorbs carbon dioxide gas in the intermediate gas by vacuum regeneration pressure swing adsorption or pressure swing adsorption or a carbon dioxide gas separation membrane that selectively passes carbon dioxide gas in the intermediate gas.

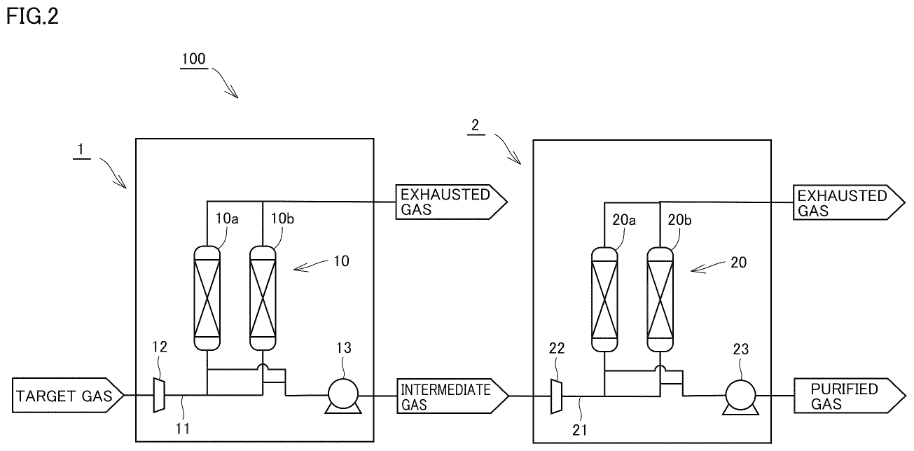

FIG. 2 is a schematic diagram showing an example of configuration of an apparatus for producing a purified gas according to an embodiment of the present disclosure. Hereinbelow, the apparatus for producing a purified gas will be described. It should be noted that a description overlapping with the above description in <Method for producing purified gas>will not be repeated. Further, the apparatus for producing a purified gas according to the present disclosure is described with reference to a case where the apparatus has a two-stage configuration including a first concentration device and a second concentration device, but the configuration of the apparatus is not limited to a two-stage configuration, and a concentration device may further be included

### (First Concentration Device)

A first concentration device 1 is a device that produces an intermediate gas having a higher concentration of carbon dioxide gas than a target gas by vacuum regeneration pressure swing adsorption using a first adsorption tower 10 that adsorbs carbon dioxide gas from the target gas containing carbon dioxide gas. That is, first concentration device 1 is a vacuum regeneration pressure swing adsorption device.

First adsorption tower 10 is filled with a carbon dioxide gas adsorbent to recover carbon dioxide gas contained in the target gas. The target gas is led into first adsorption tower 10 by a first blower 12 through a target gas conduit pipe 11, and carbon dioxide gas contained in the target gas is adsorbed to the carbon dioxide gas adsorbent. Then, the pressure of the adsorbed gas is reduced by a first vacuum pump 13 to obtain an intermediate gas. It should be noted that a gas not adsorbed to the adsorbent is discharged as exhausted gas.

The first adsorption tower 10 is filled with a moisture adsorbent to recover moisture contained in the target gas This configuration avoids the need of providing a dehumidifying part before introducing the target gas to the first adsorption tower 10, thus allowing the facility to be simplified.

As described above, the carbon dioxide gas adsorbent and moisture adsorbent filling the first adsorption tower are preferably filling in the inlet side of the first adsorption tower 10 (the target gas introduction side of the first adsorption tower 10. (in the lower side of the first adsorption tower 10 in FIG. 2)). Filling in such a manner allows carbon dioxide gas and moisture to be efficiently adsorbed on the adsorbents.

As described above, first concentration device 1 preferably includes two or more first adsorption towers 10. In FIG. 2, first concentration device 1 is constituted from two first adsorption towers (a first adsorption tower 10a and a first adsorption tower 10b), and therefore an intermediate gas can continuously be produced by leading the target gas into first adsorption tower 10a and first adsorption tower 10b alternately.

### (Second Concentration Device)

A second concentration device 2 is a device that produces a purified gas having an even higher concentration of carbon dioxide gas than an intermediate gas and that includes a second adsorption tower 20 that adsorbs carbon dioxide gas in the intermediate gas by vacuum regeneration pressure swing adsorption or a membrane separation device that selectively passes carbon dioxide gas in the intermediate gas. In FIG. 2, second concentration device 2 is a vacuum regeneration pressure swing adsorption device

### (1) Vacuum Regeneration Pressure Swing Adsorption Device

Second adsorption tower 20 is filled with a carbon dioxide gas adsorbent to recover carbon dioxide gas contained in the intermediate gas. The intermediate gas is led into second adsorption tower 20 by a second blower 22 through an intermediate gas conduit pipe 21, and carbon dioxide gas contained in the intermediate gas is adsorbed to the carbon dioxide gas adsorbent. Then, the pressure of the adsorbed gas is reduced by a second vacuum pump 23 to obtain a purified gas. It should be noted that a gas not adsorbed to the adsorbent is discharged as exhausted gas or joined with the intermediate gas and again introduced into second adsorption tower 20.

As described above, second concentration device 2 preferably includes two or more second adsorption towers 20, In FIG. 2, second concentration device 2 is constituted from two second adsorption towers (a second adsorption tower 20a and a second adsorption tower 20b), and therefore an intermediate gas can continuously be produced by leading the intermediate gas into second adsorption tower 20a and second adsorption tower 20b alternately

### (2) Pressure Swing Adsorption Device

This device (not shown) has the same configuration as the vacuum regeneration pressure swing adsorption device except that this device does not include the second vacuum pump 23 included in the above-described vacuum regeneration pressure swing adsorption device.

### (3) Membrane Separation Device

The device (not shown) includes a separation membrane module to allow carbon dioxide gas contained in the intermediate gas to selectively pass through. The intermediate gas is led into the separation membrane module by an intermediate gas compression machine so that carbon dioxide gas contained in the intermediate gas is separated by a separation membrane to obtain a purified gas.

### EXAMPLES

Hereinbelow, Examples will be described. However, the following examples are not intended to limit the claims.

### Examples 1 to 8

A target gas having a carbon dioxide gas concentration shown in Table 1 was prepared. An apparatus for producing a purified gas was prepared which had vacuum regeneration pressure swing adsorption devices as a first concentration device and a second concentration device. A purified gas was produced in accordance with the above-described method for producing a purified gas. The conditions of the first concentration device and the second concentration device are as follows. The flow rate of the target gas and the flow rate of the intermediate gas are as shown in Table 1. The first concentration device used zeolite as a carbon dioxide gas adsorbent. The first concentration device used activated alumina as a moisture adsorbent in Examples 1 to 6, silica gel in Example 7, and hydrophobic zeolite in Example 8. The second concentration device used activated alumina as a carbon dioxide gas adsorbent. It should be noted that a purge step was not performed. “PVSA” in Table 1 indicates a vacuum regeneration pressure swing adsorption device.

### (Conditions of First Concentration Device)

Adsorption pressure: 30: kPaG
Regeneration pressure: −90 kPaG
Temperature: 40° C.

### (Conditions of Second Concentration Device)

Adsorption pressure: 0.1 MPaG
Regeneration pressure: −90 kPaG
Temperature: 40° C.

### Examples 9 to 11

A target gas having a carbon dioxide gas concentration shown in Table 1 was prepared. The same device as used in Examples 1 to 6 was prepared as a first concentration device, and a pressure swing adsorption device was prepared as a second concentration device. The conditions of the first concentration device are the same as those in Example 1. The first concentration device used zeolite as a carbon dioxide gas adsorbent and activated alumina as a moisture adsorbent. The conditions of the second concentration device are as follows. The flow rate of the target gas and the flow rate of the intermediate gas are as shown in Table 1. The second concentration device used activated alumina as a carbon dioxide gas adsorbent. It should be noted that a purge step was not performed. “PSA” in Table 1 indicates a pressure swing adsorption device.

### (Conditions of Second Concentration Device)

Adsorption pressure: 0.7 MPaG
Regeneration pressure: atmospheric pressure
Temperature: 40° C.

### Example 12

A target gas having a carbon dioxide gas concentration shown in Table 1 was prepared. The same device as used in Examples 1 to 6 was prepared as a first concentration device, and a membrane separation device was prepared as a second concentration device. The conditions of the first concentration device are the same as those in Example 1 The first concentration device used zeolite as carbon dioxide gas adsorbent and activated alumina as a moisture adsorbent. The conditions of the second concentration device are as follows. The flow rate of the target gas and the flow rate of the intermediate gas are as shown in Table 1.

### (Conditions of Second Concentration Device)

Pressure: 0.5 MPaG
Temperature: 30° C.

### Comparative Example 1

A target gas having a carbon dioxide gas concentration shown in Table 1 was prepared. The same device as the membrane separation device used in Example 12 was prepared as a first concentration device, and the same device as the second concentration device used in Examples 1 to 8 was prepared as a second concentration device. The conditions of the first concentration device are the same as those in Example 12, and the conditions of the second concentration device are the same as those in Examples 1 to 8. The flow rate of the target gas and the flow rate of the intermediate gas are as shown in Table 1.

### <Evaluations>

### (Concentration of Carbon Dioxide Gas)

In Examples 1 to 12 and a Comparative Example 1, the concentration of carbon dioxide gas in an intermediate gas obtained by the first concentration device and the concentration of carbon dioxide gas in a purified gas obtained by the second concentration device were measured. The measurement was performed by gas chromatography (produced by SHIMADZU CORPORATION, model number; GC-2014AF). The results are shown in columns of “CO₂ concentration” in Table 1.

### (Evaluation of Amount of Emission of Carbon Dioxide Gas)

In Examples 1 to 12 and a Comparative Example 1, the amount of emission of carbon dioxide gas was evaluated. This is an evaluation value calculated from energy consumed and the amount of emission of carbon dioxide gas in terms of electric power. The evaluation of amount of emission is performed using the following formula (1).

Evaluation of amount of emission=electric power(KW)×CO₂coefficient(kg/KW)/amount of CO₂ recovered(kg) Formula (1)

In the formula (1), the CO₂ coefficient is defined as 0.47, In Examples 1 to 12 and a Comparative Example 1, the amount of carbon dioxide gas recovered is 10.6 kg, and therefore the amount of CO₂ recovered in the formula (1) is defined as 10.6 kg.

The results are shown in columns of “Evaluation of amount of emission” in Table 1. When smaller than 1, the value indicates that the amount of carbon dioxide gas recovered exceeds the amount of emission of carbon dioxide gas, and when larger than 1, the value indicates that the amount of emission of carbon dioxide gas exceeds the amount of carbon dioxide gas recovered. In Examples, as the evaluation value was smaller, the result of evaluation was graded as more excellent (having carbon dioxide gas reduction effect).

TABLE 1

| | | Step | | | | | | | | |
|---|---|---|---|---|---|---|---|---|---|---|
| | | First | | Second | | CO₂ concentration | | | Energy evaluation | |
| | | concentration step | | concentration step | | Target | Intermediate | Purified | Electric | Evaluation |
| | | | Flow rate | | Flow rate | gas | gas | gas | power | of amount |
| | | Device | (Nm³/hr) | Device | (Nm³/hr) | (vol %) | (vol %) | (vol %) | (kW) | of emission |
| Example | 1 | PVSA | 94 | PVSA | 8 | 10 | 72 | 98 | 11 | 0.5 |
| | 2 | | 19 | | 8 | 50 | 72 | 98 | 9 | 0.4 |
| | 3 | | 13 | | 8 | 70 | 72 | 98 | 8 | 0.4 |
| | 4 | | 171 | | 6 | 10 | 72 | 81 | 18 | 0.8 |
| | 5 | | 34 | | 6 | 50 | 72 | 81 | 14 | 0.6 |
| | 6 | | 24 | | 6 | 70 | 72 | 81 | 14 | 0.6 |
| | 7 | | 94 | | 8 | 10 | 72 | 98 | 11 | 0.5 |
| | 8 | | 94 | | 8 | 10 | 72 | 98 | 11 | 0.5 |
| | 9 | | 117 | PSA | 10 | 10 | 72 | 89 | 17 | 0.8 |
| | 10 | | 23 | | 10 | 50 | 72 | 89 | 15 | 0.6 |
| | 11 | | 12 | | 10 | 70 | 72 | 89 | 15 | 0.6 |
| | 12 | | 97 | membrane | 8 | 10 | 72 | 99 | 13 | 0.6 |

| | | | | | | | | | |
|---|---|---|---|---|---|---|---|---|---|
| Comparative | membrane | 239 | PVSA | 10 | 10 | 55 | 98 | 33 | 1.5 |
| Example 1 | | | | | | | | | |

### <Results>

As shown in Table 1, in Examples 1 to 12, a purified gas containing 80 vol % or more of carbon dioxide gas could be obtained. Further, in Examples 1 to 12, the evaluation of amount of emission of carbon dioxide gas was less than 1 in Examples 1 to 12, and the carbon dioxide gas reduction effect was confirmed.

In Comparative Example 1, a purified gas containing 98 vol % of carbon dioxide gas, which was comparable to the concentrations in Examples, could be obtained. On the other hand, the evaluation of amount of emission of carbon dioxide gas was 1.5, which was a value more than 1

As has been described above, the use of the method for producing a purified gas and the apparatus for producing a purified gas described in the present disclosure makes it possible to extract a purified gas containing a high concentration of carbon dioxide gas while reducing energy consumption. This makes it possible to reduce global greenhouse gas and contribute to some of actions for Sustainable Development Goals (SDGs). It should be noted that renewable energy may be used for electric power

The embodiments and the Examples disclosed herein are illustrative in all aspects and should be construed not to be restrictive. The scope of the present invention is defined not by the above description but by the claims, and all changes which come within the meaning and range of equivalency of the claims are therefore intended to be embraced therein.

### REFERENCE SIGNS LIST

1 First concentration device; 2 Second concentration device; 10, 10a, 10b First adsorption tower, 11 Target gas conduit pipe; 12 First blower; 13 First vacuum pump; 20, 20a, 20b Second adsorption tower; 21 Intermediate gas conduit pipe; 22 Second blower; 23 Second vacuum pump.

1. A method for producing a purified gas containing carbon dioxide gas, comprising:
a first concentration step in which an intermediate gas having a higher concentration of carbon dioxide gas than a target gas is produced by vacuum regeneration pressure swing adsorption using a first adsorption tower that adsorbs carbon dioxide gas from the target gas containing carbon dioxide gas; and
a second concentration step in which a purified gas having an even higher concentration of carbon dioxide gas than the intermediate gas is produced by vacuum regeneration pressure swing adsorption or pressure swing adsorption using a second adsorption tower that adsorbs carbon dioxide gas from the intermediate gas or membrane separation.

2. The method for producing a purified gas according to claim 1, wherein the target gas has a carbon dioxide gas concentration of 3 vol % or more and 70 vol % or less.

3. The method for producing a purified gas according to claim 1, wherein the intermediate gas has a carbon dioxide gas concentration of 50 vol % or more and 80 vol % or less.

4. The method for producing a purified gas according to claim 1, wherein the purified gas has a carbon dioxide gas concentration of 80 vol % or more.

5. The method for producing a purified gas according to claim 1, wherein the first concentration step and the second concentration step do not have a purge step to discharge impurities in the first adsorption tower and the second adsorption tower.

6. The method for producing a purified gas according to claim 1, wherein two or more of the first adsorption towers and two or more of the second adsorption towers are used.

7. The method for producing a purified gas according to claim 1, wherein in the second concentration step, carbon dioxide gas is concentrated at a higher pressure than in the first concentration step.

8. An apparatus for producing a purified gas containing carbon dioxide gas, comprising:
a first concentration device that produces an intermediate gas having a higher concentration of carbon dioxide gas than a target gas, wherein the first concentration device includes a first adsorption tower that adsorbs carbon dioxide gas in the target gas containing carbon dioxide gas by vacuum regeneration pressure swing adsorption; and
a second concentration device that produces a purified gas having an even higher concentration of carbon dioxide gas than the intermediate gas, wherein the second concentration device includes a second adsorption tower that adsorbs carbon dioxide gas in the intermediate gas by vacuum regeneration pressure swing adsorption or pressure swing adsorption or a membrane separation device that selectively passes carbon dioxide gas in the intermediate gas.

9. The apparatus for producing a purified gas according to claim 8, comprising two or more of the first adsorption towers and two or more of the second adsorption towers.
